(19) United States
(12) Patent Application Publication
(10) Pub. No.: US 2004/0249660 A1
(43) Pub. Date: Dec. 9, 2004

(54) Method and apparatus for implementing a defined benefit plan

(76) Inventors: Alfred L. Williams, St. Petersburg, FL (US); Michael P. McGinty, New Port Richey, FL (US)

Correspondence Address: HOLLAND & KNIGHT LLP, ATTN: STEFAN V. STEIN/ IP DEPT., POST OFFICE BOX 1288, TAMPA, FL, 33601-1288, US

(21) Appl. No.: 10/806,343

(22) Filed: Mar. 22, 2004

Related U.S. Application Data
(60) Provisional application No. 60/456,257, filed on Mar. 20, 2003.

(51) Int. Cl. G06F 17/60

(52) U.S. Cl. 705/1

(57) ABSTRACT

A system for the presentation, implementation, and administration of a defined benefit pension plan by persons other than actuaries or Enrolled Actuaries. Computer software that accepts input pertaining to the adopting entity and participants, the assets related to the Plan (if any), calculates the contribution necessary to properly fund the Plan as well as benefit levels for all participants using generally accepted actuarial methods and assumptions, automates the review and required certification of calculations by an actuary or Enrolled Actuary, and generates a printed proposal and the legal documents, forms, and other paperwork required for the implementation and on-going maintenance of the Plan. Computer software that calculates and outputs the benefit calculations of one or more participants in the Plan at any given time (referred to as a “Daily Benefit Calculation” system).

### CROSS-REFERENCE TO RELATED APPLICATIONS

This application claims the benefit of provisional application No. 60/456,257, filed Mar. 20, 2003, the disclosure of which is hereby incorporated by reference herein.

### BACKGROUND OF THE INVENTION

1. Field of the Invention

This invention relates generally to the field of financial planning programs. More particularly, the present invention is directed toward a method and apparatus for implementing and administering a defined benefit pension plan by persons other than actuaries or Enrolled Actuaries.

2. Description of the Background Art

In an effort to regulate the establishment and maintenance of pension and profit sharing programs within the United States of America, Congress has enacted several initiatives such as the Employee Retirement Income Security Act of 1974 (“ERISA”), as amended from time to time, the disclosure of which is hereby incorporated by reference herein, that place strict regulations on these plans, requiring (among other things) that defined benefit pension plans be reviewed and certified annually by an Enrolled Actuary (as defined in ERISA) specializing in pension plans to maintain a tax-qualified status. This requirement makes presenting and illustrating such a plan to interested entities extremely difficult for individuals other than Actuaries or Enrolled Actuaries.

Generally, an entity desiring to implement a defined benefit pension plan must retain the services of an Actuary or Enrolled Actuary that specializes in such plans to calculate the contribution necessary to fund the Plan, perform various tests on the Plan to ensure compliance with ERISA regulations, generate the various legal forms and agreements necessary to implement the Plan, as well as provide annually a certification as to the Plan's funded status to the Department of Labor (or its successors or assigns).

Several computer programs exist that simplify the process of calculating the contributions and valuation of this type of pension plan. These programs are generally designed for, and utilized by, Actuaries or Enrolled Actuaries for the purpose of reducing the manual calculations that the Actuary is required to perform. There are also several computer programs available that simplify the process of calculating accrued benefit levels for participants in defined benefit plans, which are also designed for, and utilized by, Actuaries or Enrolled Actuaries.

However, there is no easy way for individuals other than Actuaries or Enrolled Actuaries to generate the calculations necessary to present, fund, and maintain a defined benefit plan, generate the necessary legal documents and forms needed to implement and administer the Plan, or calculate and present the accrued benefits of participants in the Plan.

Therefore, it is an object of this invention to provide an improvement which overcomes the aforementioned inadequacies of the prior art devices and provides an improvement which is a significant contribution to the advancement of the implementation of a defined benefit plan.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a method and apparatus for implementing a defined benefit plan.

In view of the foregoing deficiencies in the prior art, it is an object of this invention to provide individuals other than Actuaries or Enrolled Actuaries with the necessary calculations, documents, and forms to establish and maintain a defined benefit pension plan to eligible entities.

It is a more particular object of this invention to provide methods and apparatus for implementing and administering tax-qualified or non-qualified defined benefit pension plans which automate the calculation of contributions and benefits, generate required documents and forms, communicates plan data to an actuary or Enrolled Actuary for the purpose of preparing and certifying the Plan's funded status, as required.

These and other objects of the invention are accomplished by providing a data processing system which implements various documents, forms, and computer programs to meet the requirements of a defined benefit pension plan. The data processing system preferably includes a Plan Illustrator, the purpose of which is to accept input pertaining to the entity desiring to implement the Plan and its employees, calculate the contribution necessary to fund the Plan for the first year, generate illustrations that show the required contribution and estimated benefit levels that the Plan will deliver, and generate the required legal forms and documents, including, but not limited to, the Adoption Agreement, Resolution Certificate, Plan Prototype, Summary Plan Description (“SPD”) and Beneficiary Designation Forms with the object being to permit the presenter to succeed in implementing the Plan without the active involvement of an actuary or Enrolled Actuary.

A Plan Administrator accepts input information pertaining to the entity implementing the defined benefit pension plan and its employees and information pertaining to employees entering the Plan after the initial implementation. In addition, the Plan Administrator tracks contributions made to the Plan (either via manual input or electronic means), track assets accumulated in the Plan (either via manual input or electronic means), uses a Daily Benefit Calculation feature to generate Benefit Election Forms and calculate and generate Benefit Statements for participants in the Plan, calculate annually the contribution required to maintain the Plan, and make available electronically the calculations and supporting data from the Plan to an actuary or Enrolled Actuary for the purpose of preparing and delivering annually the required certification to the Department of Labor (or its successors or assigns).

An Actuarial Module calculates the values necessary for the actuarial valuation and certification, and generates completed, printed actuarial valuation reports and governmental filings. The Actuarial Module also generates Plan Documents including Adoption Agreements, Plan Prototypes, Resolution Certificates, Beneficiary Designation Forms, Benefit Election Forms, Actuarial Valuation Reports, IRS Determination Letters, SPDs, and other forms and documents required for the Plan to be recognized as a tax-qualified (or non-qualified) defined benefit pension plan under ERISA.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a pictorial of the Illustrator contribution calculation computer program;

FIG. 2 is a pictorial of the printed illustration generated by the Illustrator;

FIG. 3 is a pictorial of the Illustrator interview screen;

FIG. 4 is a pictorial representation of a Plan Selection Screen and a Plan Details Screen of an embodiment of the present invention;

FIG. 5 is a pictorial representation of a Participant Administration Screen and a Contribution Ledger Screen in accordance with an embodiment of the present invention;

Similar reference characters refer to similar parts throughout the several views of the drawings.

### DETAILED DESCRIPTION OF THE PREFERRED EMBODIMENT

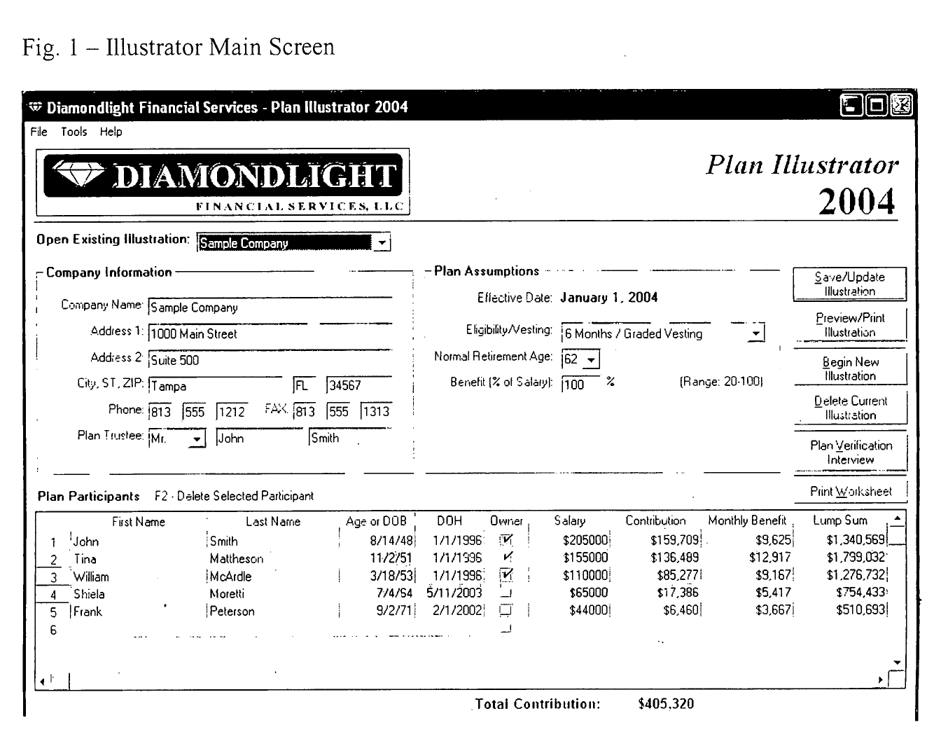

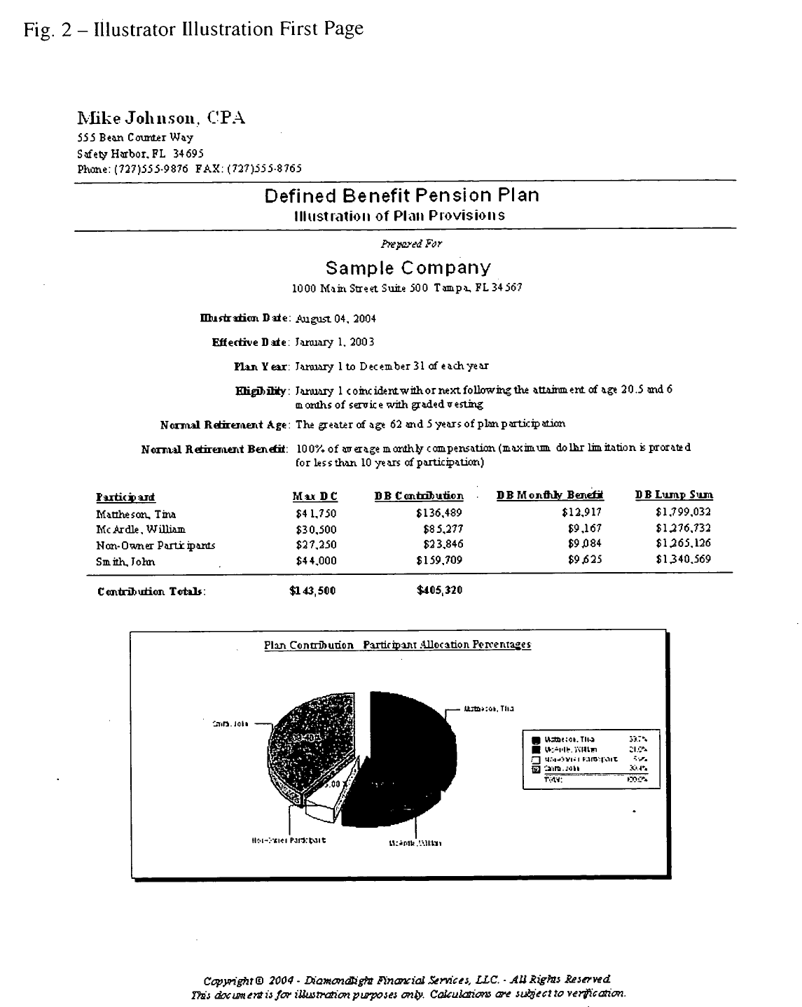

Referring now to FIG. 1, the system of the present invention includes an actuary or Enrolled Actuary and an individual other than an actuary or Enrolled Actuary (hereinafter referred to as a “Broker”). An authorized representative of an entity desiring to implement a defined benefit pension plan provides pertinent details regarding the entity and its employees to the Broker, who enters the data into the Plan Illustrator. The Plan Illustrator calculates the first year contribution necessary to implement the Plan and generates a printed illustration (FIG. 2) of the calculations for consideration by the entity.

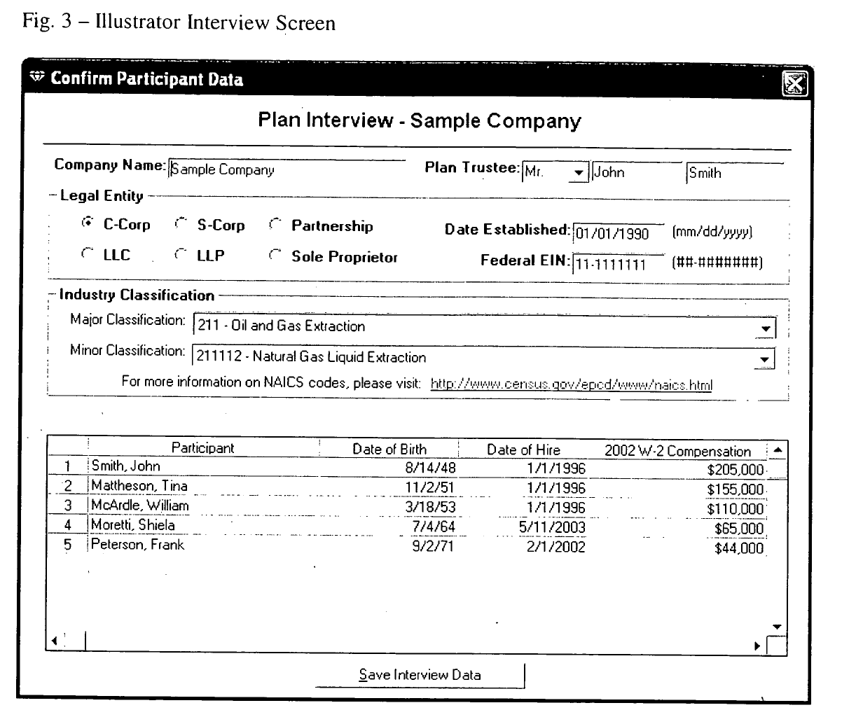

Referring now to FIG. 3, the Broker indicates acceptance of the Plan by the entity by inputting additional details regarding the entity and its participants, at which time the Broker is able to cause the Illustrator to generate the documents and forms necessary to implement the Plan, including, but not limited to, an Adoption Agreement, Resolution Certificate, Plan Prototype, SPD, and Beneficiary Designation Forms. The Broker then indicates receipt of the executed documents and forms by initiating an electronic transmission of the Plan details to the computer system maintained by the actuary or Enrolled Actuary and the delivery of physical copies of the executed documents to the actuary or Enrolled Actuary. From this point forward, in an effort to maintain the accuracy and integrity of plan data, all data is stored, and calculations made, on a digital computer system maintained by the actuary or Enrolled Actuary (hereinafter referred to as the “Server”). The Plan Administrator electronically transmits inputted data to the Server where it is validated, stored electronically, relevant calculations are performed, and the results returned electronically to the Plan Administrator and Broker for display.

The actuary or Enrolled Actuary indicates receipt of the executed documents by marking the Plan “Active”, at which time the Plan is recognized as implemented. The actuary or Enrolled Actuary causes the Actuarial Module to generate a first year actuarial valuation report, which is then certified by the actuary by his or her signature and/or raised seal and delivered to the Broker for delivery to the entity having adopted the Plan.

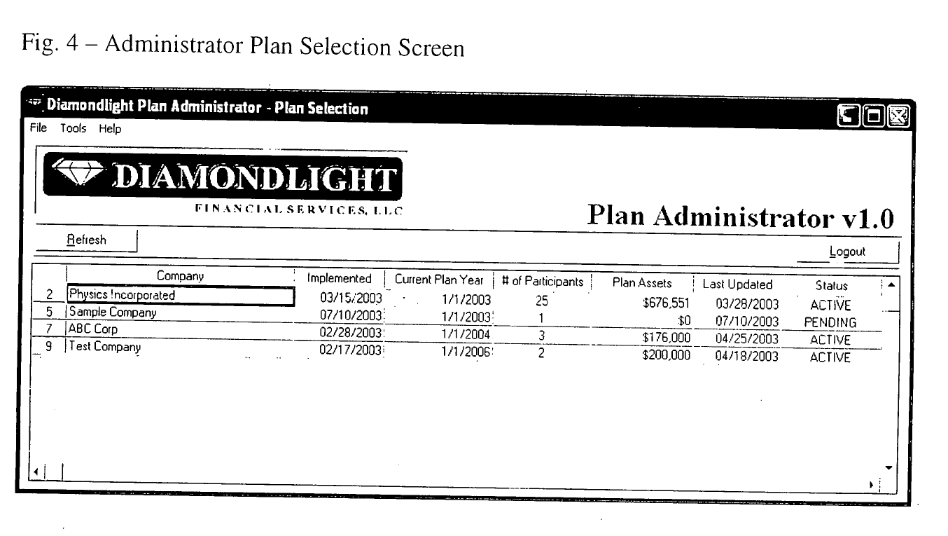

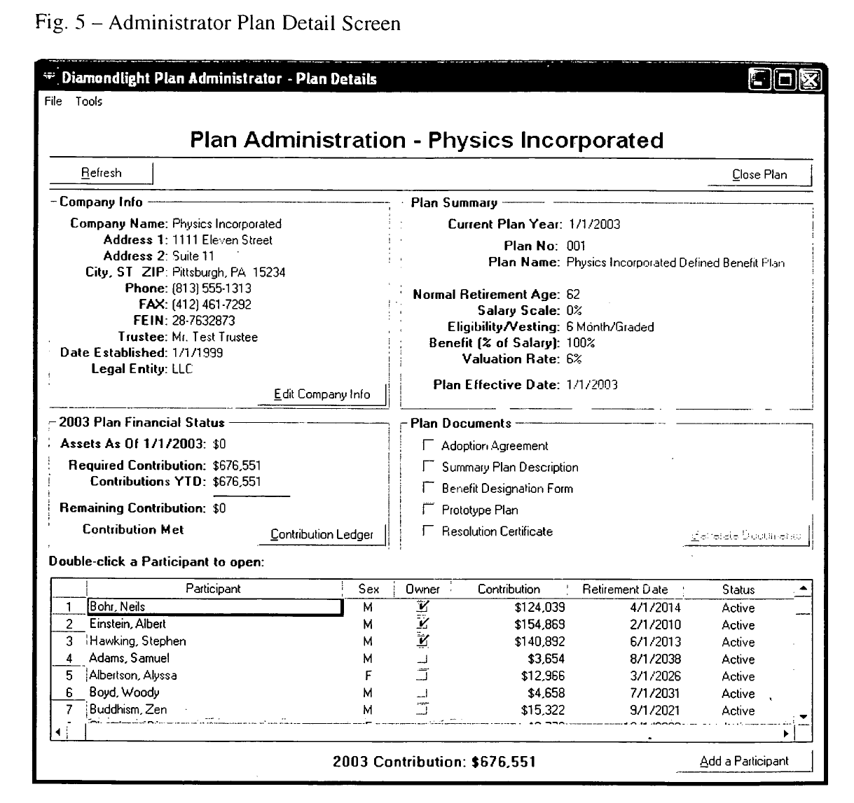

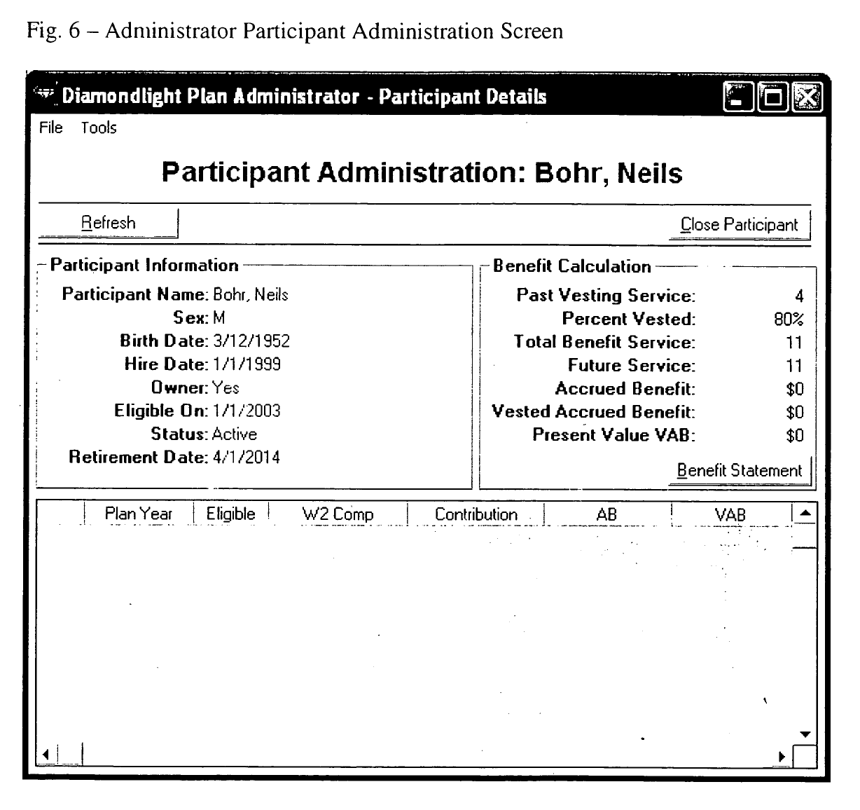

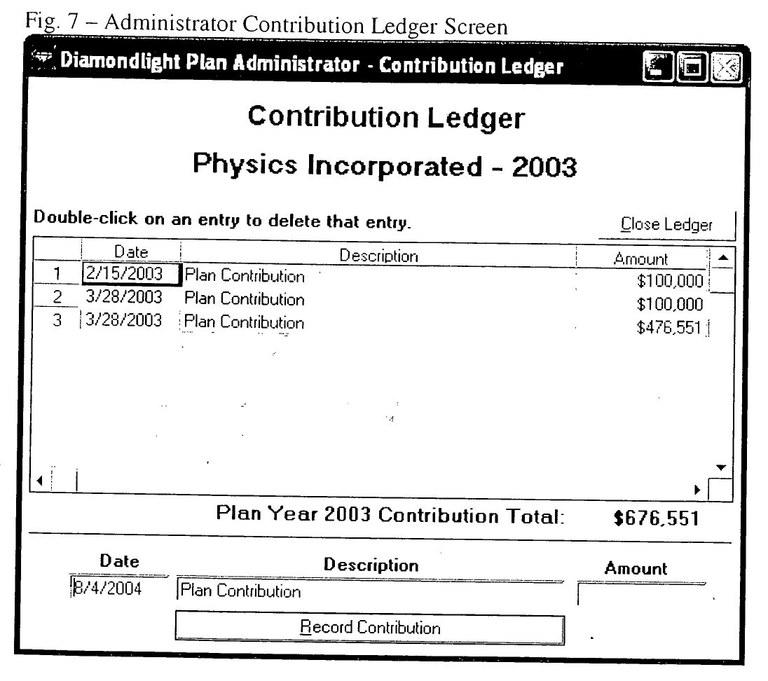

The Broker then administers the Plan using the Plan Administrator (FIG. 4 and FIG. 5). Administration includes the addition of new participants, new information regarding existing participants, the indication of change of status of terminated or retired participants, and contributions made to the Plan. The broker is also able to cause the Plan Administrator to generate the aforementioned Plan documents, as well as to calculate accrued benefits and generate a printed benefit statement using the Daily Benefit Calculation feature of the invention. Upon meeting the required contribution for the current plan year, the Broker is able to cause the Plan Administrator to accept year-end census data regarding the entity and its employees and to then provide the Broker with a calculation of the required contribution for the next plan year.

This process continues until the Plan is terminated either because (a) All participants have retired, died, or have been terminated and paid their benefits under the Plan, or (b) The Plan is voluntarily or involuntarily terminated. In the event of plan termination, the actuary or Enrolled Actuary causes the Actuarial Module to generate a calculation and output detailing the allocation of the assets in the Plan. This calculation is delivered to the Broker for delivery to the participating entity, and the Plan is marked as terminated by the actuary or Enrolled Actuary once all of the Plan's remaining participants have been paid their allocable benefits under the Plan.

Utilizing the above described methods and apparatus, persons other than actuaries or Enrolled Actuaries are able to illustrate, implement, and administer tax-qualified or non-qualified defined benefit pension plans for eligible entities. Required interaction with an actuary or Enrolled Actuary is automated to a large extent, permitting a large volume of plans to be managed by relatively few persons.

The invention as described above facilitates the implementation of a defined benefit pension plan, such as ERISA. The methodology and formulas employed in the ERISA plan are well known to those skilled in the art. Representative textbooks and publications that define such formulas and methodology include “The Theory of Interest” by Stephan Kellison, Second Edition, Library of Congress Catalogue Numbers 79-98251 and 91-16494, ISBN 0-256-09150-1, publisher: McGraw-Hill/Irwin, Chicago, Ill. and “Life Contingencies” by C. W. Jordan, Second Edition, Library of Congress Number 67-31240, published by the Society of Actuaries, Chicago, Ill., the disclosures of each of which are hereby incorporated by reference herein.

Representative actuarial assumptions and methodology utilized in the invention may include:

Actuarial Cost Method: Individual Aggregate

Actuarial Assumptions:

Investment Yield: 6.00% per annum pre-retirement and post-retirement,

Actuarial Value of Assets: Fair market value of assets as of the valuation date,

Pre-retirement Mortality: None,

Post-retirement Mortality: 1994 Group Annuity Reserving Mortality Table,

Assumed Retirement Age: Normal Retirement Age,

Salary Scale: None,

Withdrawal: None,

Disability: None, and

Expenses: Investment return is net of expenses.

Representative actuarial cost method utilized in the invention may include the “Individual Aggregate” Actuarial Cost Method. In this regard, an actuarial valuation is a series of mathematical calculations which project future benefits under a pension plan and future contributions to fund those benefits. The true cost of a pension plan cannot be determined until the last benefit is paid, because the true cost is the actual benefits ultimately paid, plus the expense of maintaining the plan, less the actual income earned on invested funds. Since funding cannot wait until the last benefit is paid, actuarial assumptions are used to project ultimate benefit levels and the reserves needed to provide them. An actuarial cost method is then used to establish a reasonable pattern of contributions to accumulate those reserves. The assumptions and cost method themselves, therefore, only impact the incidence of funding, not the true cost. Each new valuation automatically corrects for any differences between the assumptions and actual experience, and the correction is spread over the current and future years of funding.

The Individual Aggregate actuarial cost method spreads the funding of each participant's pension benefits over his/her future service as a level dollar amount or a level percentage of participant compensation. The calculated year-by-year funding requirement is referred to as the normal cost of the plan.

Each year, the Actuarial Value of Assets is allocated to the individual participants for the purposes of funding, only. In the first year this cost method is utilized, assets are allocated to each active participant in the same proportion that his/her present value of accrued benefits bears to the total of the present value of all active participants' accrued benefits. This allocation to active participants is performed using the net assets remaining following the allocation of assets equal to the present value of benefits to each retired, terminated vested, and active participant at the assumed retirement age. For years subsequent to the first year in which this cost method is used, assets are allocated to each active participant in the proportion that the sum of the allocated assets and calculated normal cost as of the valuation date for the prior year for that active participant bears to the total of such amount for all active participants.

The calculation of the normal cost is made in a manner that assumes payment at the end of the plan's fiscal year. Investment gains or losses due to contributions actually being made at any other time during the plan's fiscal year are recognized in the next valuation.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of steps or parts may be resorted to without departing from the spirit and scope of the invention.

Now that the invention has been described,

What is claimed is:

1. A computer program for the presentation, implementation and administration of a benefit plan, said program comprising:
an input routine for accepting input information pertaining to an adopting entity and plan participants;
a benefit calculation routine for calculating a contribution level for each plan participant necessary to properly fund the plan and a corresponding benefit level for each plan participant;
an actuary review routine for formatting information related to said input information, contribution levels and benefit levels and performing certification calculations to facilitate review by an actuary or enrolled actuary; and
a form generating routine for generating forms and legal documents necessary to implement and maintain the benefit plan.

2. The computer program of claim 1 further comprising a daily benefit routine that allows a plan participant's benefits to be calculated and output upon request.

3. The computer program of claim 1 further comprising a communication routine for electronically communicating information to an actuary so that the actuary may prepare and certify the a funded status of the benefit plan.

4. The computer program of claim 1 wherein the form generating routine generates at least one of an Adoption Agreement, Resolution Certificate, Plan Prototype, SPD and Beneficiary Designation Form.

5. The computer program of claim 1 wherein the actuary review routine electronically provides the calculations and supporting data from the benefit plan to the actuary or enrolled actuary for the purpose of preparing and delivering annually the required certification to the Department of Labor.

6. A data processing system for implementing various documents, forms, and computer programs required to meet the requirements of a defined benefit plan, said data processing system comprising:
a plan illustrator for accepting input information pertaining to an entity desiring to implement the defined benefit plan and its employees; calculating a required contribution necessary to fund the plan for a specified time period; generating illustrations that show the required contribution; estimating benefit levels that the defined benefit plan will deliver and generating required legal forms and documents;
a plan administrator for tracking contributions made to the plan and tracking assets accumulated in the plan;
a form generator for generating benefit election forms and benefit statements for participants in the defined benefit plan; and
an actuary supporter for generating certification data and electronically providing such certification data to an actuary for the purpose of preparing and delivering the required certification for the plan.
